(19) United States
(12) Patent Application Publication
(10) Pub. No.: US 2012/0102516 A1
(43) Pub. Date: Apr. 26, 2012

(54) COMMUNICATIONS SYSTEM

(75) Inventor: Robert Perkins, London (GB)

(73) Assignee: British Telecommunications PLC, London (GB)

(21) Appl. No.: 13/379,857

(22) PCT Filed: Jul. 9, 2010
(86) PCT No.: PCT/GB10/01319

§ 371 Date: Dec. 21, 2011

(30) Foreign Application Priority Data
Aug. 12, 2009 (EP) 09251979.2
Sep. 8, 2009 (GB) 0915604.3

(51) Int. Cl. H04N 21/00; G06F 3/00

(52) U.S. Cl. 725/14; 725/37

(57) ABSTRACT

Supplementary data associated with a broadcast transmission (5, 26) is made available to the viewer by identifying the content currently being received at a user terminal (2). The user generates a request for data which includes the identity of the broadcast content. This request is transmitted from the user terminal (2) to a content provision platform (4). The content provision platform retrieves supplementary data associated with the identified broadcast content and delivers the supplementary data to a predetermined return address (9).

This invention relates to communications systems, and in particular to systems which integrate broadcast and interactive services.

A feature of modern digital broadcast services is the provision of supplementary data or associated channels; accessible in response to a user input which causes the supplementary data to be displayed instead of, (or as well as), the original channel. Such data may include subtitles, additional information on a particular item in a broadcast etc. However, viewing such additional data at the time of transmission can disrupt the viewing of the main broadcast programme.

The present invention provides a system by which supplementary information can be accessed subsequent to the broadcast programme. Some embodiments also allow the information to be retrieved even if the programme is not viewed at the time of broadcast but as a recording.

One known system developed by Backchannelmedia Inc of Boston, Mass., inserts data into broadcast content which causes icons to be displayed on suitably configured receiver equipment. If a user operates a control whilst the icon is on display it causes an Internet address “hyperlink” associated with the icon to be stored in a location from where it can be accessed subsequently by the user.

The present invention adopts a different approach, which avoids the need to modify the broadcast content.

It is known to provide communications units which, in addition to accepting input data from a broadcast service (e.g. through a standard television aerial) can also be connected to a data communications network such as the Internet. Such systems use the data communications network for download of additional services such as electronic programme guide (EPG) data. Unlike the broadcast input, the data communications network connection is bi-directional, so it can also be used for services requiring an uplink, such as “on-demand” streaming services. Input from both sources (broadcast and internet) is converted by the communications unit to a form suitable for display on a monitor device, typically a standard television receiver. The communications unit is typically controlled by a remote-control unit.

International Patent specification WO2008/080006 (Apple) describes a process in which the user of a communications device, whilst viewing broadcast content on that device, can use it to request that supplementary information be sent to the device, the supplementary information relating in some way to the broadcast content. For example the user may wish to put a name to a tune. However, such an approach is not always convenient, particularly if the request is for very detailed content, or if the received content would disrupt viewing of a broadcast. This is more particularly relevant for applications where more than one person may be expected to be viewing the broadcast content, or where the viewer(s) would not want to interrupt the broadcast content to view the requested data.

It is also known to provide broadcast or streamed audio-visual material to a general-purpose computer over a communications network such as the internet

According to a first aspect of the present invention, there is provided a communications terminal for processing data, the terminal comprising a receiver for receiving broadcast content, a transmitter for transmitting a request for supplementary data, a control input for receiving control signals, and a processor for identifying the content currently being received by the receiver, and generating a request for additional content associated with the currently-received content to be transmitted to a predetermined address other than that of the generator of the request, and for transmitting the generated request to a predetermined service provider.

The service provider to which the request is transmitted may provide content itself, or may retrieve the content from a separate content provider for transmission to the specified address.

Associated with this first aspect is a complementary aspect which provides a content provision processor having a data comparison processor for identifying a concordance between broadcast content and supplementary data associated with the broadcast content, an input for receiving data requests from one or more client devices identifying broadcast content and a delivery address other than the origin of the request, a retrieval system for retrieving the supplementary data associated with the broadcast content identified in such requests, and a transmission system for transmitting the retrieved supplementary data to the delivery address specified in the request.

The invention also provides a method of retrieving supplementary data associated with a broadcast transmission by identifying the broadcast content currently being received at a receiver; generating a request for data, the request including the identity of the broadcast content, transmitting the request to a content provision processor, at the content provision processor retrieving supplementary data associated with the identified broadcast content and delivering the supplementary data so identified to a predetermined delivery address other than that of the generator of the request.

The term “broadcast content” is used here to mean any content made available to a large number of receivers, either simultaneously or on demand. If the content is transmitted and viewed in real time, the identification of the broadcast content for which supplementary data is required can be made by identifying the channel currently being viewed and the time of the request, the concordance then being made with the transmission schedule of the channel in question. Delivery of such content may be over a conventional television broadcast system using wireless transmitters, or by cable access or over a general data communications system such as the Internet. The latter may be used for broadcast-type services or on-demand services.

If the input content is not a live broadcast but a recording of a broadcast made at some earlier time, the identification of the content for which supplementary data is required would require not only the channel but the exact start time of the recording to be captured, as well as the point in the recording which has been reached. Alternatively, the content can instead be identified using “acoustic fingerprinting”, in which an extract of the content is recorded and transmitted to the platform to identify the content in question. This could, for example, be a distinctive sound track such as an advertising jingle. This method would allow content to be identified when viewed “on demand”, or as a replay of a recording made by the user.

The user may be given the option of requesting data on content that has been transmitted recently (e.g. within the last minute), rather than at the instant of the request. This allows time for a user to react to the advertisement of other content, and to locate the control device. In this case the request generation processor may adjust the time specified in the request, or the segment of transmission to be used for acoustic fingerprinting, accordingly. Alternatively, the time delay may be incorporated in the request, and allowed for in the processing at the remote platform.

The supplementary data may be transmitted to a user device other than the communications terminal on which the main content is received. Typically, it may be in the form of an email or text message giving access details (such as a website address) for more detailed content. By sending this to a different terminal it prevents interruption of the original content, and allows individual users viewing the same programme to specify different destinations for the content they individually require.

Embodiments of the invention will now be described, by way of example, with reference to the Figures, in which:

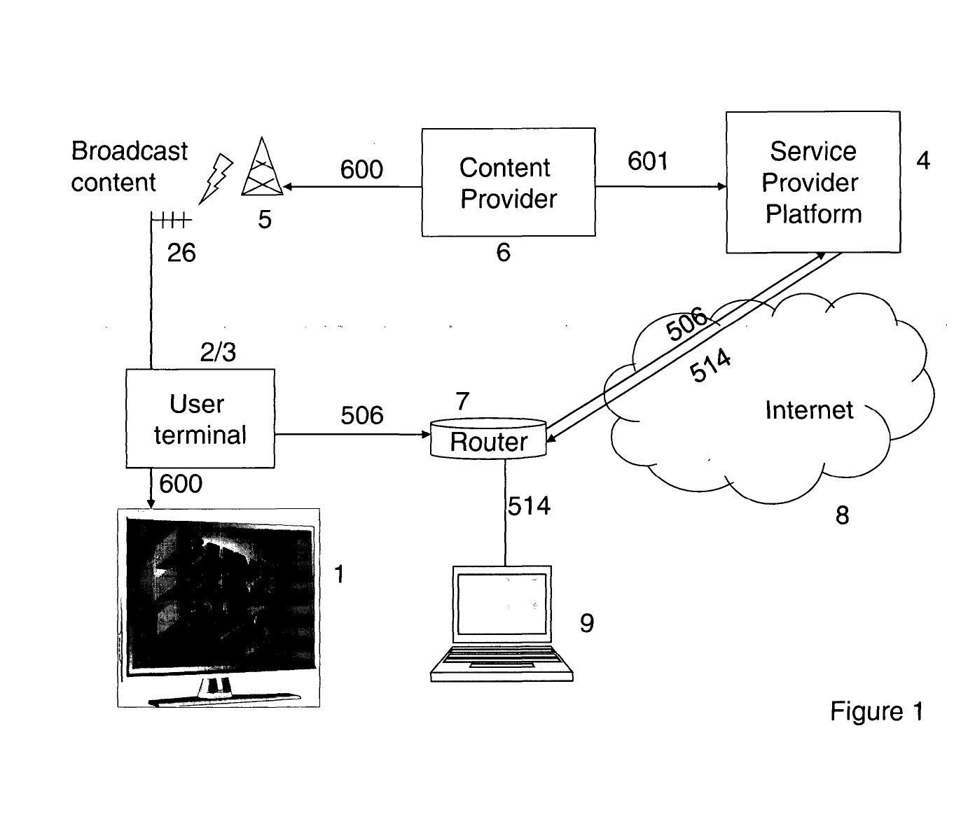

FIG. 1 is a schematic illustration of the various elements cooperating to form the invention.

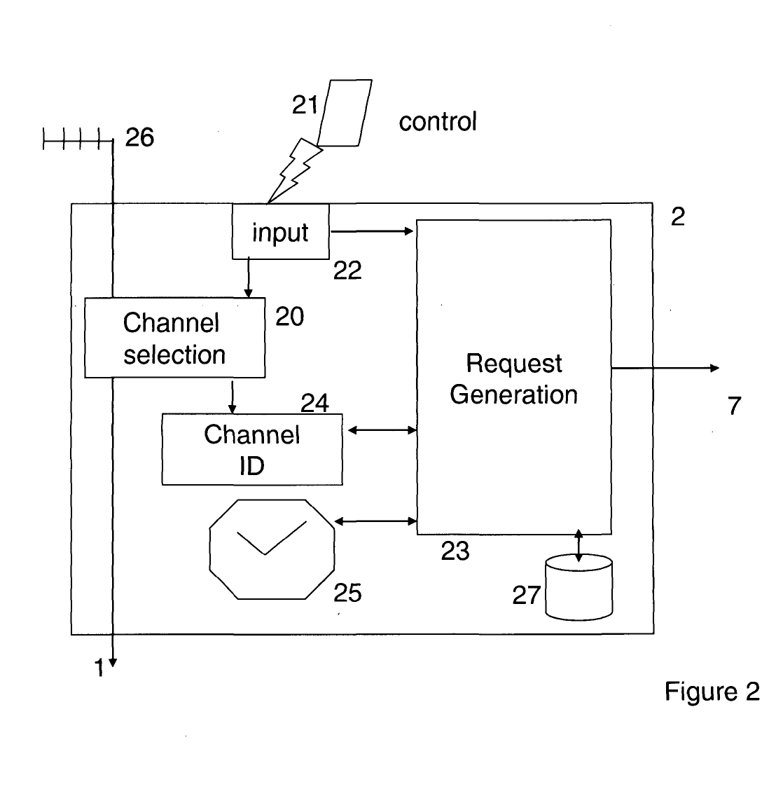

FIG. 2 is a schematic diagram of a first embodiment of the communications platform of FIG. 1

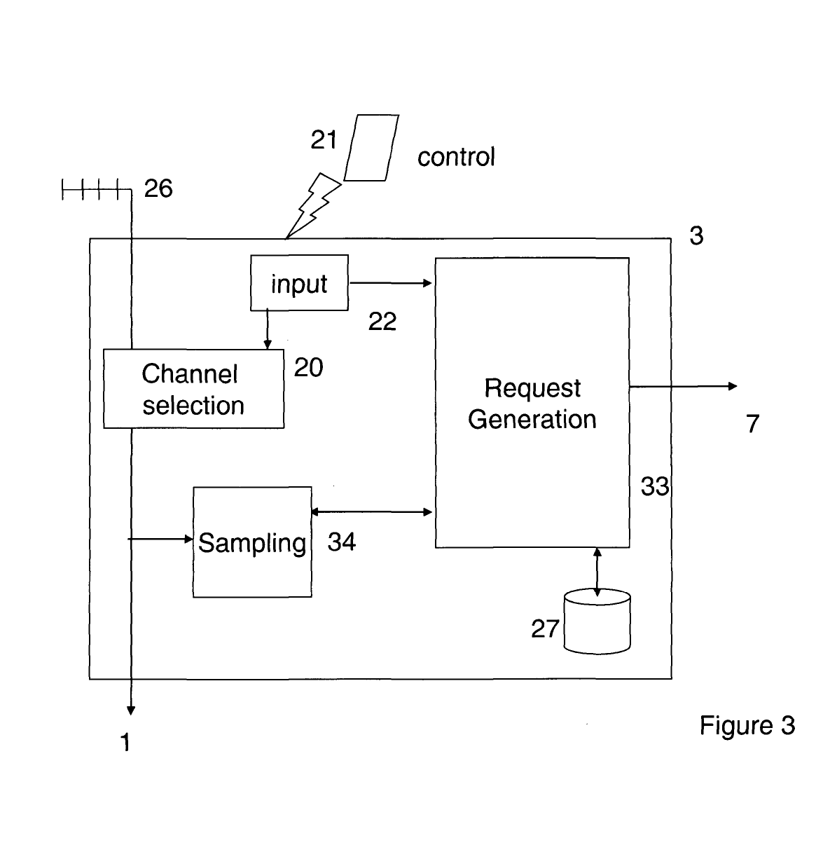

FIG. 3 is a schematic diagram of a second embodiment of the communications platform of FIG. 1

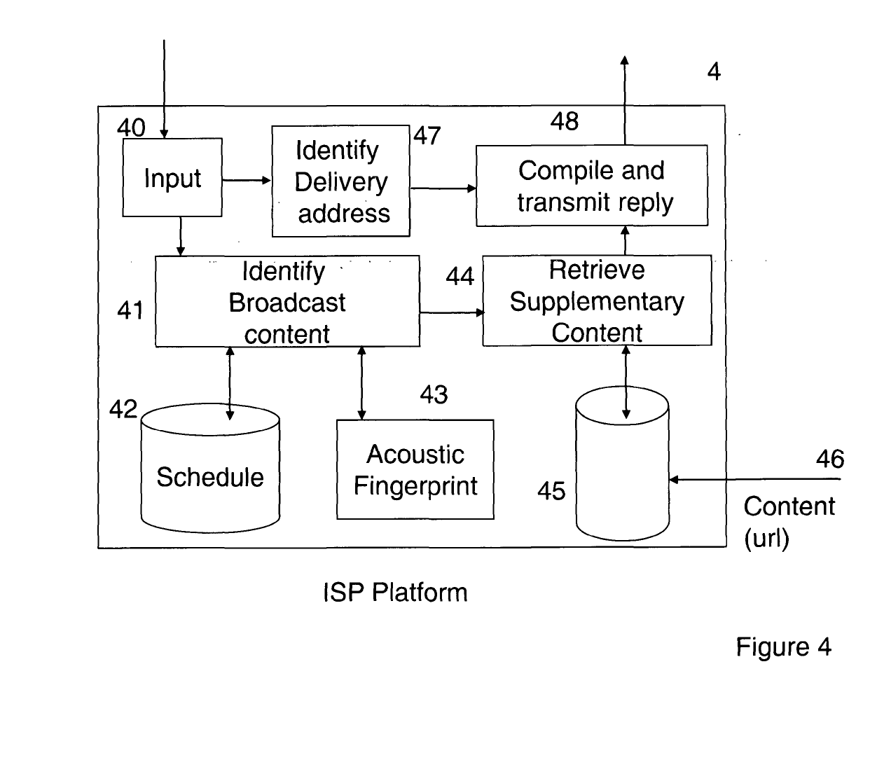

FIG. 4 is a schematic diagram of the content provision platform of FIG. 1

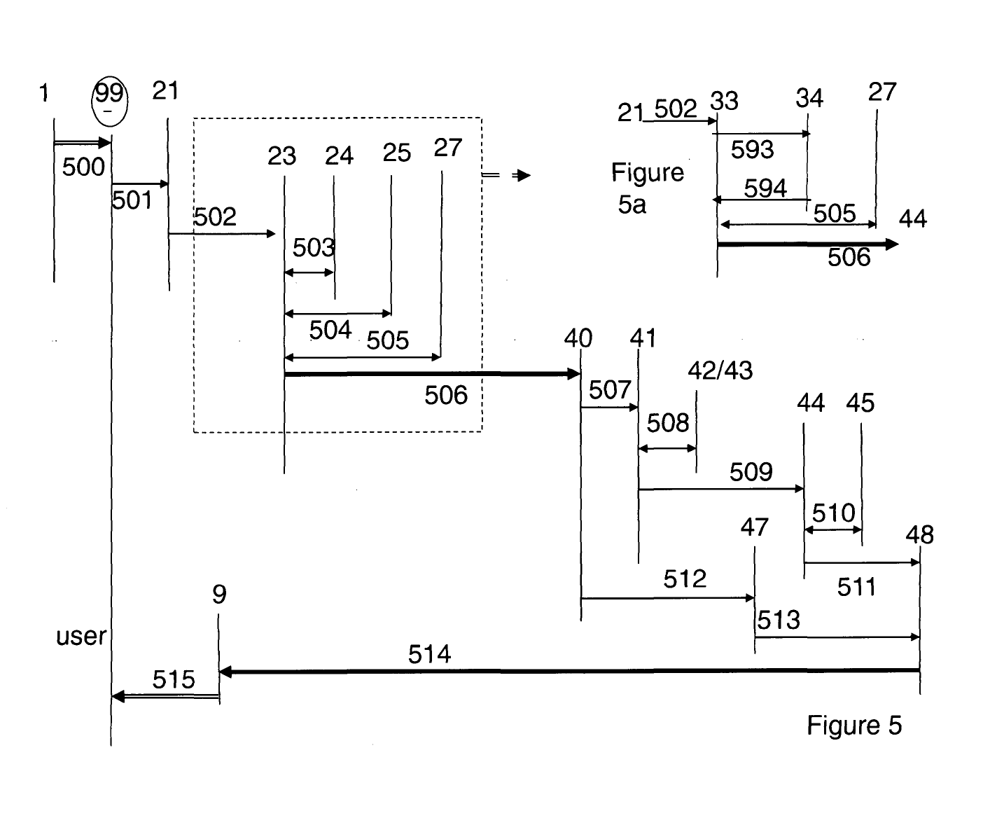

FIG. 5 is a flow diagram illustrating the information flows taking place during the operation of the invention

FIG. 5a depicts a variant of part of the flow diagram of FIG. 5

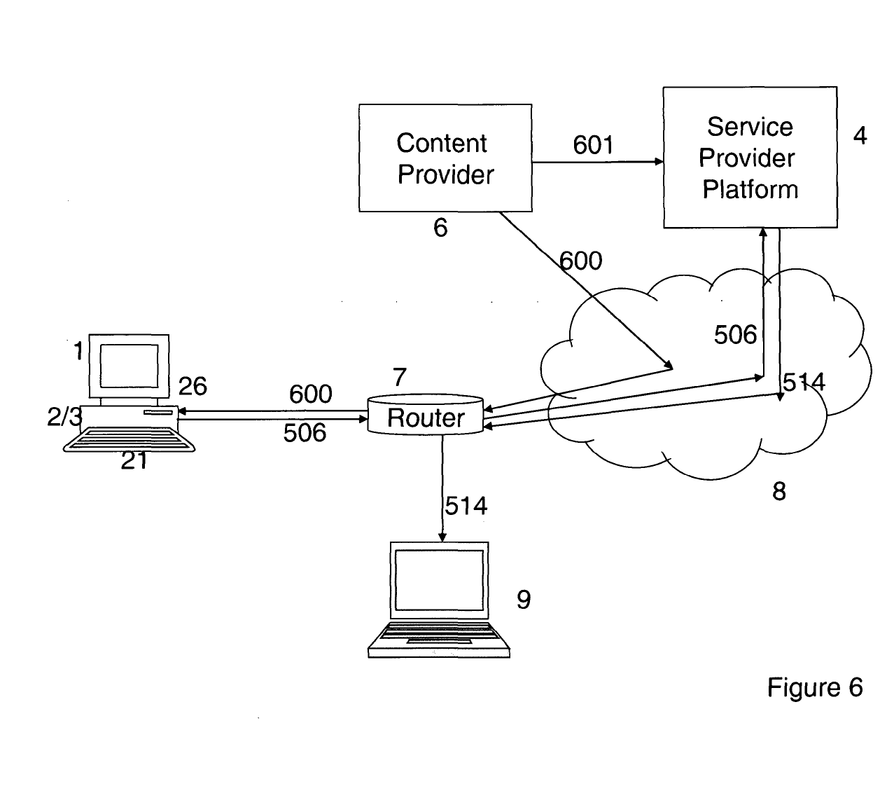

FIG. 6 is a variant of FIG. 1, illustrating the application of the invention to an alternative method of content delivery

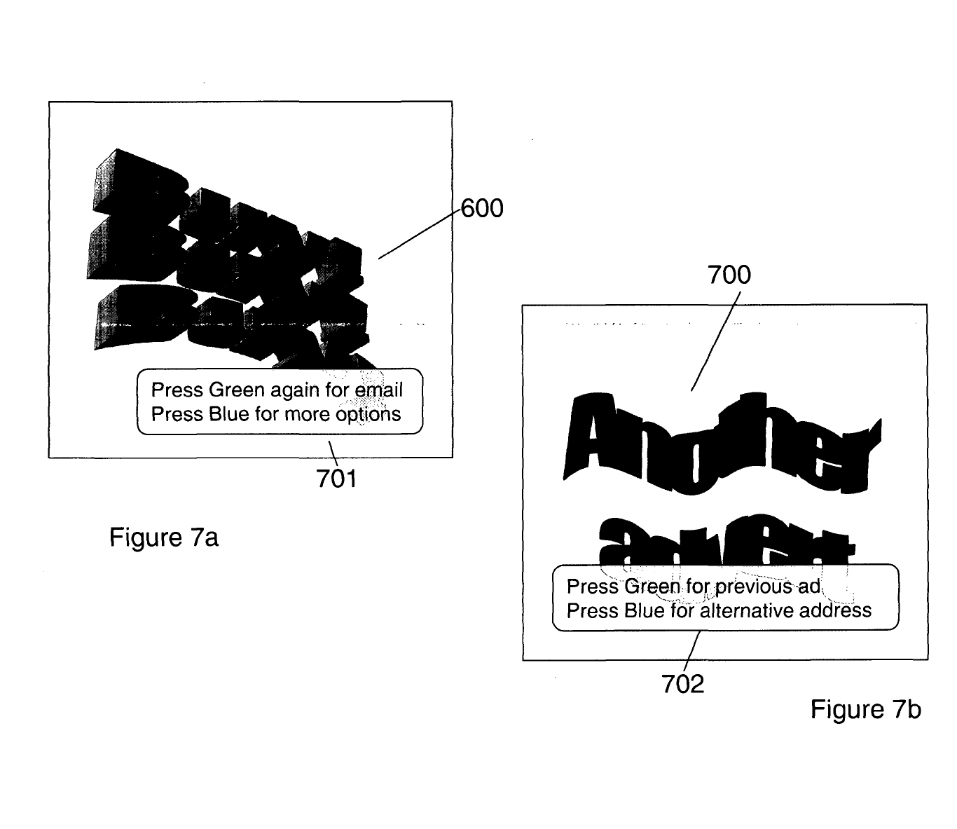

FIGS. 7a and 7b are screenshots illustrative of the prompts provided to a user of the system.

As depicted in FIG. 1, a user terminal (2 or 3) has an input 26 from a source 6 of transmitted material 600. As shown this input 26 is a television aerial for receiving transmissions broadcast from a content provider 5 through a transmitter 6 (terrestrial or satellite). The input may instead be from a cable TV service. In some embodiments the input may be material played back from a recording device, which has previously recorded the material from a broadcast source. As is conventional, the material is displayed on a television set 1.

The user terminal (2 or 3) also has a data connection through a router 7 which acts as the interface between user equipment 2, (3), 9 and a data communications network 8 such as the Internet.

Also shown in FIG. 1 is a service provision platform 4 accessible from the data communications network 8. This platform has a data feed 601 from the content provider 6.

FIG. 2 depicts a first embodiment of the user terminal 2 depicted in FIG. 1. This has the conventional functions of a digital television “set-top box”, in particular a channel selection unit 20 controlled by a user input 22, shown as controlled by a remote control unit 21.

Some devices of this type also have a connection 7 to a data communications network 8, to allow services such as on-demand video streaming, electronic programme guides, etc. The present invention makes use of this connection for a further capability, embodied in an information request generation unit 23. This unit is responsive to an input from the user 21 to retrieve data relating to the content currently being viewed and transmit this data to a remote server together with an address for response retrieved from a store 27. The content may be identified from the current status of a channel monitoring unit 24, which is controlled by the channel selection unit 20 to identify the television channel currently being viewed, and the time the request is made as determined by an internal clock 25.

The control 21 may allow an input to identify a time to be calculated other than the current instant, for example 30 seconds previously.

The control 21 may also have provision to control the request generation unit to select one response address from several stored in the address store 27.

FIG. 3 is a schematic diagram of an alternative user terminal 3 which may be used in place of the user terminal 2 shown in FIG. 2. The components 20, 21, 22, 26, 27 common to the embodiments will not be discussed again in detail.

In this arrangement the request generation unit 33 is responsive to the input 22 to operate a sampling unit 34 to extract a sample of the content being delivered to the user 1. The sampling unit 34 may incorporate a buffer to allow content recently viewed or heard by the user to be used. The sample is coded to an acoustic fingerprint or “tag” such as used by the music discovery search engine “Shazam”, and the tag forms part of the request to be transmitted by the request generation unit 33

It should be noted that the capabilities of both embodiments of FIGS. 2 and 3 may be incorporated in a single user terminal, to allow either of the two alternative processes to be used selectively according to circumstances. The embodiment of FIG. 2 is potentially more reliable for live transmissions, but cannot easily be used with recorded material unless the channel and exact start time of the recording was captured at the time the recording was originally made.

FIG. 6 illustrates a configuration which differs from that of FIG. 1 in that primary content 600 is delivered to a personal computer ⅔ by way of the data communications network 8. The personal computer ⅔ is configured to provide the functions depicted in FIGS. 2 and/or 3, and to receive and process such content and display it on its own monitor 1. The input device for such a computer is typically a keyboard 21 (as shown) or a “mouse”, rather than the remote control unit depicted in FIGS. 2 and 3. As shown in FIG. 6, the personal computer ⅔ and the user terminal 9 are separate computers connected through the same router 7, but they may instead be connected to different routers or, conversely, one computer may serve both functions.

FIG. 4 illustrates the functional elements required at a service provider's platform 4 suitable for co-operation with the user terminals of both FIGS. 2 and 3. Although depicted as a integrated unit the various functional elements may be distributed amongst several items of hardware, and may be duplicated for capacity or reliability.

The platform 4 has a store 45 for supplementary data provided through an interface 46 with one or more content providers 5. The platform 4 also stores the broadcast schedule 42 in sufficient detail that it can identify which content 600 is currently being broadcast at the point that a request for supplementary data 601 is generated. If the primary broadcast content is advertising material, this requires a schedule of the advertisements transmitted in he broadcast. The platform 4 also has an acoustic fingerprinting processor 43 for identifying content from a sampled extract. It will be apparent that the functional elements 42, 43 are specific to the request types generated by the respective user terminals 2, 3 depicted in FIGS. 2 and 3, and either of them can be omitted if the platform is intended for use only with the other request type.

The platform 4 has an input unit 40 connected to a data communications network 8 for receiving information requests from user terminals 2, 3 connected to the network. This input is analysed by a broadcast identification unit 41 which identifies the primary content being viewed at the time the request was made, either from scheduling information (42) or from content analysis (43). A supplementary data retrieval unit 44 is controlled by the broadcast identification unit 41 to retrieve content related to the identified content. This content can be a universal resource locator (url) or Internet address giving access to more comprehensive data.

An addressing unit 47 is provided to extract return address data incorporated in a request received at the input 44. A reply compiler 48 generates a reply, for example in the form of an email, addressed to the return address retrieved by the addressing unit 47 and containing the data retrieved by the supplementary data retrieval unit 46, and transmits it through a data communications network—generally, but not necessarily, the same network 8 as that over which the request was received.

In operation, the co-operating elements of the invention perform as will now be described with reference to FIGS. 5 and 5a.

A viewer 99 seeing an item of interest 500 on the television 1 may wish to have more information than is contained in the transmission. For example, a short advertisement may prompt the viewer to seek further details. The invention does not require any metatags or other extra data to be overlaid into the broadcast content, although the content of the advertisement may of course mention that users who have the invention installed in their user terminals can seek further details of the advertised product or service by pressing the appropriate button on the control unit to initiate the method of the invention.

The further information is available at a location 45 in the platform 4 operated by the service provider. This data is typically an email address or url (universal resource locator) for the advertiser's website. As the data to be delivered to the user comes from a single platform operated by a provider to whom the user has subscribed, the user can have confidence that he is not exposing himself to unknown or unfamiliar websites, and after receiving the contact details he can review them before deciding whether to establish contact with the advertiser itself. Again, because the content 45 is provided by the user's service provider, content can also be tailored to individual users, for example by providing a variant appropriate to the user's address or preferred language, or by barring access to inappropriate sites if the user has requested such a restriction.

In order to obtain this information, the user 99 operates a special key or sequence of key strokes on the control unit 21 (step 501). As shown in FIG. 2, this is the same control unit 21 that controls functions such as channel selection 20, but a separate control unit may instead be provided for these functions.

In response to the keystroke or sequence of such strokes the control unit transmits a control signal 502 to the request generation unit 23. In the simplest form of the invention this control signal 502 simply causes the request-generation function (503, 504) to be initiated. However, more complex requests may be made available, for example to select between different types of content associated with the currently-received content, such as whether information is required relating to the current advertisement or the one preceding it. This feature would allow a user time to locate the remote control device. The control signals may also be used to differentiate different addresses 9 to which the supplementary content may be sent, for example to allow different members of the same household to have content sent to their respective addresses 9.

As shown in FIGS. 7a and 7b, the generation of more complex requests may be assisted by prompts generated by the user terminal 2 for display on the television screen 1. FIG. 7a depicts a first prompt screen 701 which would appear superimposed on the broadcast content 600 in response to the initial keystroke (referred to here as “Green”). The user is prompted to press the same key (“Green”) to have the supplementary content sent to a primary email address, or to press a second key (“Blue”) for other options.

FIG. 7b depicts a second prompt 702 which would appear in response to pressing the second key in response to the prompt 701 depicted in FIG. 7a. This allows the user to request a different supplementary content (specifically, in this example, content relating to the advertisement 600 which preceded the advertisement 700 now being transmitted) by pressing the “Green” key, or alternatively to select a different email address for the requested content by pressing the “Blue” key. The keystrokes and prompts described here are of course illustrative, and other functions and prompts may be used in addition or instead.

Several control units 21 may be provided, each associated with a different address 9 and each capable of sending request signals 501. The request generation function 23 can be arranged to identify which control unit generated the request, and therefore to which address 9 the data is to be sent.

The operation of the request-generation unit 2, 3 differs in the two embodiments. The operation of the embodiment of FIG. 2 is illustrated in FIG. 5, whilst for the embodiment of FIG. 3 the steps 593, 594, 595 illustrated in FIG. 5a replace the steps 503, 504 delineated by the box in FIG. 5.

In the embodiment of FIG. 2 the request generation unit 23 interrogates the output 24 from the channel selection unit 20 (step 503), and also identifies the current time (step 504) from an internal clock 25. For better synchronisation, the clock may itself be driven from a broadcast source 26. This information therefore identifies the time and channel on which the primary, content was transmitted. As mentioned previously, the time can be adjusted, for example to identify the previous advertisement rather than the current one

If the user terminal 2 has a recording function, it may be capable of recording the channel and start time of recordings that it makes, and this data may be used to generate similar requests during playback of the recording by calculation of the original time of transmission of the part of the recording that was being viewed when the user operates the control (501).

FIGS. 3 and 5a illustrate an alternative method of generating requests for supplementary information. In this embodiment the request generation unit 33 transmits an instruction (593) to a sampling unit 34 to take an extract from the content currently being delivered to the television screen 1. In a preferred embodiment a buffering facility is provided so that the sampling unit can extract the content that had been transmitted immediately before the user 99 generated the request 501, 502. The buffering period may be adjusted to allow material from either the current advertisement or a previous one to be extracted.

The sampling unit 34 generates a sound file 594 which is returned to the request generation unit 33.

The request generation unit 33 now compiles a data request 506. This includes the data identifying the primary content (either channel and time, 503, 504) or sound file (594), and the address to which the data is to be sent, retrieved from the address store 27 (step 505). As indicated previously, the input 502 may indicate which of several addresses is to be used, and also may indicate whether the requested data is for the actual time or for a preceding segment in the broadcast.

The data request 506 is transmitted over the data communications network 8 to the service provider platform 4.

The service provider platform responds to such data requests as follows. As previously mentioned, the request includes data identifying primary broadcast content and an address to which a response is to be sent. The content data 507 may be channel and time data (see FIG. 2) or a sound clip (see FIG. 3). This is forwarded to an analysis unit 41, which interrogates a database 42 or 43 (step 508). The database 42 matches time and channel data to the original television schedule 601 (supplied to the service provider 4 from the broadcaster 6) to identify the content that was being transmitted at the specified time—or immediately preceding that time if the request so specifies. In the alternative embodiment, the database 43 performs an “acoustic fingerprint” process to identify the content. For advertising material, the fingerprint may be a “jingle” or a readily-identifiable trade mark or strap-line.

Having identified the primary content, the platform 4 then passes the request to a retrieval unit 44 (step 509) to retrieve the supplementary data associated with it (step 510). The supplementary data is maintained in a store 45 to which content is delivered either by the service provider 4 itself, or by the various content providers 46. This supplementary data typically consists of a link to the advertiser's website.

The supplementary data is delivered (step 511) to a message compiler 48 which generates a reply 514 to the original data request 506. In the preferred embodiment this reply is a message addressed to the user's email address 9, identified in an addressing unit 47 which retrieves the user identity from the input 506 (step 512), converts it to a user address 513 which it passes it to the message compiler. The reply address could instead be for example an IP address, a telephone number (for receipt of a text message), the network address of a similar device such as another user's set-top box, or a postal address (to generate an automated mailshot). The message contains the supplementary data 511 retrieved from the store 45. The message complier 48 may tailor this message to the individual customer according to details held on the service provider's own customer database, such as location, content restrictions, etc.

The complied message 514 is then transmitted over the data communications network 8 to the user address 9 specified in the address header 513. As shown in FIG. 1, the destination user address 9 is served by the same network interface router 7 as the user terminal 2 from which the request is transmitted, but this is not limitative—the destination can be any internet address specified by the user.

The message 514 can then be viewed by the user 99 (step 515) at a time and place convenient to him without interrupting his own viewing of the original programme content 500, or the viewing of anyone else watching with him, and can choose whether, and when, to download the content available at the advertiser's url.

1. A communications terminal for processing data, the terminal comprising a receiver for receiving broadcast content, a transmitter for transmitting a request for supplementary data, a control input for receiving control signals, and a processor for identifying the content currently being received by the receiver, and generating a request for additional content associated with the currently-received content to be transmitted to a predetermined address other than that of the generator of the request, and for transmitting the generated request to a predetermined service provider.

2. A terminal according to claim 1, further comprising a channel monitor for identifying the channel currently being received by the terminal at the time a request is generated.

3. A terminal according to claim 1, comprising a sampling unit for recording an extract of the broadcast content for transmission with the request.

4. A terminal according to claim 1, wherein the controller is capable of selecting the time of transmission of the broadcast content for which supplementary data is required.

5. A terminal according to claim 1, wherein the processor is capable of selecting to which of a plurality of destinations the supplementary content is to be delivered.

6. A terminal according to claim 1, wherein the receiver is arranged to receive RF television signals.

7. A terminal according to claim 1, wherein the receiver is arranged to receive streamed video signals over a data connection.

8. A content provision processor having a data comparison processor for identifying a concordance between broadcast content and supplementary data associated with the broadcast content, an input for receiving data requests from one or more client devices identifying broadcast content and a delivery address other than the origin of the request, a retrieval system for retrieving the supplementary data associated with the broadcast content identified in such requests, and a transmission system for transmitting the retrieved supplementary data to the delivery address specified in the request.

9. A processor according to claim 8, wherein the retrieval system identifies, from data in the request, the channel currently being viewed and the time of the request, and retrieves data from a stored concordance with a transmission schedule of the channel in question.

10. A processor according to claim 8, wherein the retrieval system provides means for comparing an extract of the broadcast content with a database of recorded content.

11. A processor according to claim 8, wherein the retrieval system identifies a time offset between the identified broadcast content and the content for which supplementary data is required.

12. A processor according to claim 8, wherein transmission system transmits the supplementary data in the form of a data message giving access details for more detailed content.

13. A method of retrieving supplementary data associated with a broadcast transmission by identifying the broadcast content currently being received at a receiver, generating a request for data, the request including the identity of the broadcast content, transmitting the request to a content provision processor, at the content provision processor retrieving supplementary data associated with the identified broadcast content and delivering the supplementary data so identified to a predetermined delivery address other than that of the generator of the request.

14. A method according to claim 13, wherein identification of the broadcast content for which supplementary data is required is made by identifying the channel currently being viewed and the time of the request, the concordance then being made with the transmission schedule of the channel in question.

15. A method according to claim 13, wherein identification of the broadcast content for which supplementary data is required is made by recording an extract of the broadcast content and comparing it with a database of content.

16. A method according to claim 13, wherein a user input selects the time of transmission of the broadcast content for which supplementary data is required.

17. A method according to claim 13, wherein the supplementary data is transmitted in the form of a data message giving access details for more detailed content.

18. A method according to claim 13, wherein a user input selects to which of a plurality of destinations the supplementary content is to be delivered.
